(19) United States
(12) Patent Application Publication
(10) Pub. No.: US 2008/0163888 A1
(43) Pub. Date: Jul. 10, 2008

(54) Oral cleanliness and gum massage device

(76) Inventor: Kuan-Jou Chen, Shulin City (TW)

Correspondence Address: TROXELL LAW OFFICE PLLC, 5205 LEESBURG PIKE, SUITE 1404, FALLS CHURCH, VA, 22041, US

(21) Appl. No.: 11/896,467

(22) Filed: Aug. 31, 2007

(30) Foreign Application Priority Data
Sep. 14, 2006 (TW) 095216457

(51) Int. Cl. A61C 15/04; A61H 13/00

(52) U.S. Cl. 132/323; 132/329; 601/139

(57) ABSTRACT

An oral cleanliness and gum massage device, which includes U-shaped end portion, at least one lower protruding body or side protruding body and a dental floss. The aforementioned U-shaped end portion is connected to a handle portion, and the aforementioned lower protruding bodies or side protruding bodies are disposed at a lower portion or a side of the U-shaped end portion. The aforementioned dental floss is positioned on two endpoints of the U-shaped end portion.

### BACKGROUND OF THE INVENTION

(a) Field of the Invention

The present invention relates to a cleaning device, and more particularly to an oral cleanliness and gum massage device.

(b) Description of the Prior Art

Maintenance of healthy teeth has already become part of general health knowledge of modern people that cannot be neglected. However, it is necessary to have effective tools to do good work, and apart from having a regular checkup at a dental hospital or the dentist, moreover, a supplementary device for cleaning the oral cavity is necessary in order to accurately and thoroughly clean the teeth, and thereby maintain an optimum condition of the oral cavity.

In particular, dental atrophy could result in persons having large gaps between the teeth or suffering from periodontal disease because of improper brushing of the teeth or bone damage, causing large crevices. At such a time, common cleaning devices are unable to thoroughly clean the gaps between the teeth which a toothbrush is unable to clean, and is a problem periodontal disease sufferers will specifically come across.

In addition, simple cleaning devices such as toothpicks, and the like, cannot easily thoroughly clean the rear surfaces of the teeth. Moreover, dental flossers commonly seen in the market can frequently only clean a portion of tooth crevices. Hence, there is a need to introduce an oral cleanliness and gum massage device that is able to thoroughly clean the gaps between the teeth which a toothbrush is unable to clean, and which is further able to thoroughly clean the rear surfaces of the teeth and the majority of tooth crevices, while at the same time have the ability to massage the gums.

Accordingly, the inventor of the present invention, having realized the need for improvement in the aforementioned shortcomings, has meticulously carried out extensive study and exploration in conjunction with utilization of scientific theory to ultimately propose the present invention, which provides a reasonable design and that effectively improves the aforementioned shortcomings.

### SUMMARY OF THE INVENTION

One objective of the present invention is to provide an oral cleanliness and gum massage device able to clean the gaps between the teeth or the teeth and the massage the gums, thereby enabling cleaning and caring for the health of the oral cavity even more convenient.

In order to achieve the aforementioned or other objectives, the oral cleanliness and gum massage device provided by the present invention comprises a U-shaped end portion, at least one lower protruding body or side protruding body and a dental floss. The aforementioned U-shaped end portion is connected to a handle portion, and the aforementioned lower protruding bodies or side protruding bodies are disposed at a lower portion or a side of the U-shaped end portion. The aforementioned dental floss is positioned on two endpoints of the U-shaped end portion.

The aforementioned oral cleanliness and gum massage device is able to massage the gums and thoroughly clean the gaps between the teeth, moreover, is able to thoroughly clean the rear surfaces the teeth and the majority of teeth crevices.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an elevational schematic view depicting the structure of an embodiment of an oral cleanliness and gum massage device according to the present invention.

FIG. 2 shows a structural schematic view depicting a U-shaped end portion and a handle portion before disposition of a collar.

FIG. 3 shows a side schematic view of the oral cleanliness and gum massage device.

FIG. 4 shows a schematic view of an oral cavity depicting areas which can be cleaned by a preferred embodiment of the present invention.

### DETAILED DESCRIPTION OF THE PREFERRED EMBODIMENTS

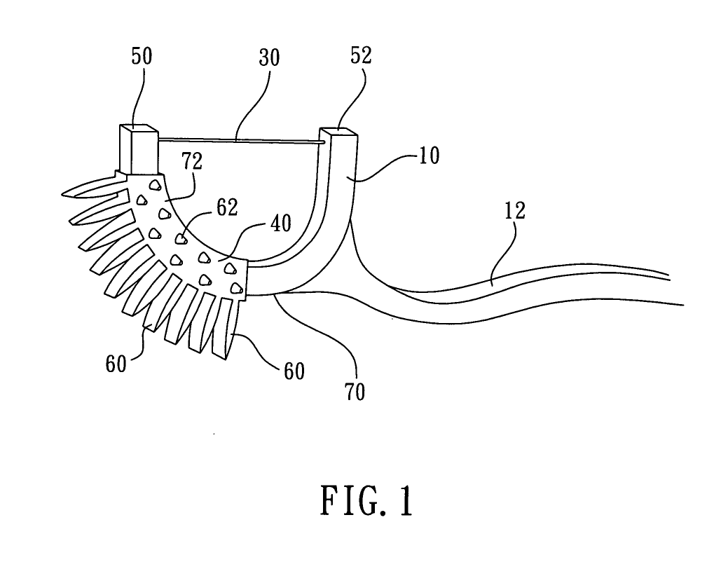

Referring to FIG. 1, which shows a schematic view depicting a structural elevational view of a preferred embodiment of an oral cleanliness and gum massage device according to the present invention, wherein the oral cleanliness and gum massage device comprises a U-shaped end portion 10, at least one lower protruding body 60 or side protruding body 62 and a dental floss 30. The U-shaped end portion 10 is connected to a handle portion 12, and the lower protruding bodies 60 are disposed at a lower portion 70 of the U-shaped end portion 10. The side protruding bodies 62 are disposed at a side 72 of the U-shaped end portion 10. The protruding bodies of the lower protruding bodies 60 and the side protruding bodies 62 can be rigid bodies or elastic bodies. Ends of the lower protruding bodies 60 and the side protruding bodies 62 can be pointed, plane surface or inclined planes. The protruding bodies of the lower protruding bodies 60 and the side protruding bodies 62 can be bristles, and the dental floss 30 is located between a first endpoint 50 and a second endpoint 52 of the U-shaped end portion 10.

The aforementioned oral cleanliness and gum massage device may further comprise a collar 40, which surrounds the U-shaped end portion 10, in which the at least one lower protruding body 60 or side protruding body 62 are joined to the collar 40. In addition, the collar 40 and the lower protruding bodies 60 or side protruding bodies 62 are formed as an integral body. The collar 40 and the lower protruding bodies 60 or side protruding bodies 62 can be fabricated from thermoplastic elastomer (TPE). Thermoplastic elastomer (TPE), also called thermoplastic rubber (TPR), is a material which melts under high temperature, and under normal processing temperatures is a material providing cured rubber properties, having characteristics including high tensility and low compression deformation, low processing costs, easy processing/avoiding vulcanizing, excellent rubber touch, good mechanical properties, hundred percent recyclable, low temperature resistant characteristics, resistant to chemical reagents, excellent stretchability, excellent weathering resistance, and so on.

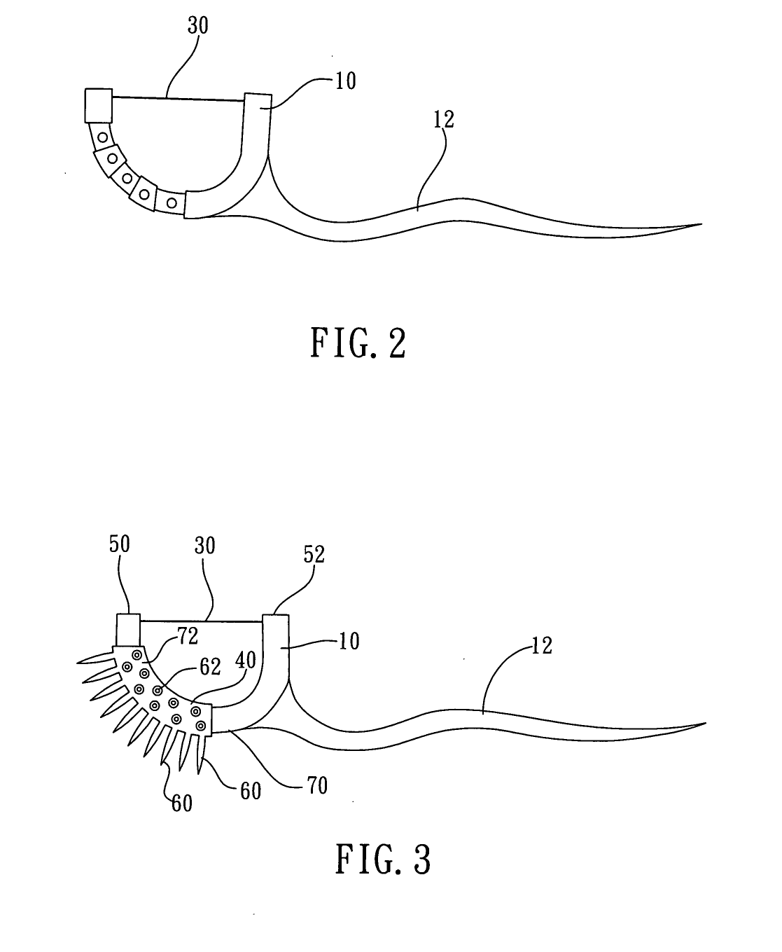

Referring to FIG. 2, which depicts a structural schematic view of the U-shaped end portion 10 and the handle portion 12 before disposition of the collar 40, wherein width of a lower left portion of the U-shaped end portion 10 is less than the width of other portions thereof, one of the objectives of which is to enable the collar 40 (see FIG. 1) to be effectively mounted on the U-shaped end portion 10, and thereby enable secure disposition of the at least one lower protruding body 60 or side protruding body 62 (see FIG. 1) on the U-shaped end portion 10, thus providing a structure that is conducive to stability in use and the serviceable life of the lower protruding bodies 60 or side protruding bodies 62.

Referring to FIG. 3, the lower protruding bodies 60 or the side protruding bodies 62 can be used to thoroughly clean the gaps between the teeth which a toothbrush is unable to clean, thereby cleaning away food debris or tartar in the gaps between the teeth, and thus improving cleanliness of adjacent surfaces of the teeth. Moreover, the lower protruding bodies 60 or the side protruding bodies 62 can also be used to scrape away a coating on the tongue, and a dental floss 30 can be used to clean tight small gaps between the teeth. Hence, it can be understood that the present invention has advantages of providing both the dental floss 30 and the lower protruding bodies 60 or providing both the dental floss 30 and the side protruding bodies 62, thereby achieving dual effectiveness of being complete in both respects.

It is noteworthy that, the dental floss 30 and the lower protruding bodies 60 or the dental floss 30 and the side protruding bodies 62 disposed on the U-shaped end portion 10 enable the user to only lightly hold and rotate the handle portion 12 with the fingers to realize alternate use of the dental floss 30 and the lower protruding bodies 60 or the dental floss 30 and the side protruding bodies 62 when using the oral cleanliness and gum massage device of the present invention, thus providing the present invention with considerable convenience. In addition, for convenience of use, the handle portion 12 can be designed with a suitable streamline shape, as depicted in FIG. 3.

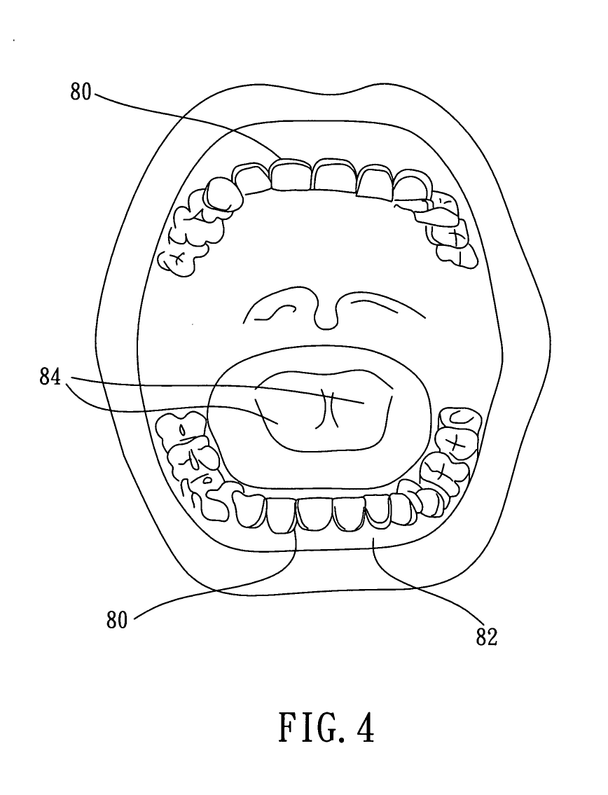

Referring to FIG. 4, which shows a schematic view depicting an oral cavity, and in conjunction with FIG. 1, which depicts the preferred embodiment of the oral cleanliness and gum massage device of the present invention, the lower protruding bodies 60 or the side protruding bodies 62 can be used to clean the gums 82, and more particular are able to clean the portions close to the teeth 80, which are portions the dental floss 30 are unable to clean. In addition, the lower protruding bodies 60 or the side protruding bodies 62 can be used to scrape a coating 84 on the tongue and massage the gums 82. It is worth mentioning that decay of the teeth often starts with the gums, therefore, using the lower protruding bodies 60 or the side protruding bodies 62 of the present invention to frequently massage the gums will encourage metabolism thereat, increase gum resistance and be conducive to preventing periodontal disease.

Furthermore, the handle portion 12 being jointly used by the lower protruding bodies 60 or the side protruding bodies 62 and the dental floss 30 of the present invention is able to simplify the entire structure and reduce manufacture costs, thereby eliminating the need for the consumer to purchase two oral cleaning devices, which not only provides convenience of use, but also saves on expense, and gives proper attention to environmental protection problems.

Moreover, the oral cleanliness and gum massage device of the present invention is able to thoroughly clean the gaps between the teeth which a toothbrush is unable to clean, and is further able to thoroughly clean the rear surfaces of the teeth and the majority of teeth crevices.

The oral cleanliness and gum massage device of the present invention can be manufactured using dual injection molding, that is, in the same mold, the handle portion 12, the lower protruding bodies 60 or the side protruding bodies 62 and the collar 40 are respectively molded at the same time using two material tubes applied in the same mold. Material for the handle portion 12 can be ABS (Acrylonitrile Butadiene Styrene) or high density PS (Polystyrene).

Looking at the present invention from another aspect, it provides a method of application for a cleaning device, wherein, first, the dental floss 30 of the aforementioned oral cleanliness and gum massage device is used to carry out cleaning of the oral cavity, and then, when the dental floss 30 is unable to achieve the cleaning objective, the fingers can be used to lightly hold and rotate the handle portion 12 of the aforementioned oral cleanliness and gum massage device to change use to brushing clean the oral cavity.

In conclusion, the present invention is truly a unique, new innovative product, provided with extreme commercial applicability, originality and advancement, thus completely complying with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An oral cleanliness and gum massage device, comprising:
a U-shaped end portion connected to a handle portion;
at least one side protruding body disposed at a side of the U-shaped end portion, and
a dental floss positioned on two endpoints, of the U-shaped end portion.

2. The oral cleanliness and gum massage device according to claim 1, wherein ends of the side protruding bodies are pointed, plane surfaces or inclined planes.

3. The oral cleanliness and gum massage device according to claim 1, wherein the side protruding bodies are bristles.

4. The oral cleanliness and gum massage device according to claim 1, wherein the side protruding bodies are joined to a side of a collar, and the collar surrounds the U-shaped end portion.

5. The oral cleanliness and gum massage device according to claim 4, wherein ends of the side protruding bodies are pointed, plane surfaces or inclined planes.

6. The oral cleanliness and gum massage device according to claim 4, wherein the side protruding bodies are bristles.

7. An oral cleanliness and gum massage device, comprising:
a U-shaped end portion connected to a handle portion;
at least one lower protruding body disposed at a lower portion of the U-shaped end portion, and
a dental floss positioned on two endpoints of the U-shaped end portion.

8. The oral cleanliness and gum massage device according to claim 7, wherein ends of the lower protruding bodies are pointed, plane surfaces or inclined planes.

9. The oral cleanliness and gum massage device according to claim 7, wherein the lower protruding bodies are bristles.

10. The oral cleanliness and gum massage device according to claim 7, wherein the lower protruding bodies are joined to a lower portion of a collar, and the collar surrounds the U-shaped end portion.

11. The oral cleanliness and gum massage device according to claim 10, wherein ends of the lower protruding bodies are pointed, plane surfaces or inclined planes.

12. The oral cleanliness and gum massage device according to claim 10, wherein the lower protruding bodies are bristles.

13. An oral cleanliness and gum massage device, comprising:
a U-shaped end portion connected to a handle portion; at least one side protruding body disposed at a side of the U-shaped end portion;
at least one lower protruding body disposed at a lower portion of the U-shaped end portion; and
a dental floss positioned on two endpoints of the U-shaped end portion.

14. The oral cleanliness and gum massage device according to claim 13, wherein ends of the side protruding bodies and the lower protruding bodies are pointed, plane surfaces or inclined planes.

15. The oral cleanliness and gum massage device according to claim 13, wherein the side protruding bodies and the lower protruding bodies are bristles.

16. The oral cleanliness and gum massage device according to claim 13, wherein the side protruding bodies and the lower protruding bodies are joined to a collar, and the collar surrounds the U-shaped end portion.

17. The oral cleanliness and gum massage device according to claim 16, wherein ends of the side protruding bodies and the lower protruding bodies are pointed, plane surfaces or inclined planes.

18. The oral cleanliness and gum massage device according to claim 16, wherein the side protruding bodies and the lower protruding bodies are bristles.
